(19) United States
(12) Patent Application Publication
(10) Pub. No.: US 2011/0286878 A1
(43) Pub. Date: Nov. 24, 2011

(54) METHOD FOR PRODUCTION OF NDFEBGA MAGNET AND NDFEBGA MAGNET MATERIAL

(76) Inventors: Hidefumi Kishimoto, Shizuoka-ken (JP); Tetsuya Shoji, Shizuoka-ken (JP); Noritsugu Sakuma, Shizuoka-ken (JP)

(21) Appl. No.: 13/145,819

(22) PCT Filed: Feb. 4, 2010
(86) PCT No.: PCT/IB2010/000216

§ 371 Date: Jul. 22, 2011

(30) Foreign Application Priority Data
Feb. 4, 2009 (JP) 2009-024143

(51) Int. Cl. B22F 1/00; H05B 1/00; B22F 3/12

(52) U.S. Cl. 419/33; 219/162

(57) ABSTRACT

An NdFeBGa magnet material has a composition that is represented by the genera formula Nd_{y}Fe_{100-x-y-z}B_{z}Gaₓ, where x is between 1 and 3 inclusive, y is between 14 and 24 inclusive, and z is between 7 and 12 inclusive.

### BACKGROUND OF THE INVENTION

1. Field of the Invention

The present invention relates to a method for producing an NdFeBGa magnet, and an NdFeBGa magnet material, and, more particularly, to a method for producing an NdFeB magnet that has a high coercivity without the addition of a large amount of a rare metal such as Dy, Tb or Co, and an NdFeBGa magnet material for the NdFeB magnet.

2. Description of the Related Art

Magnetic materials are broadly classified into two groups: hard magnetic materials and soft magnetic materials. Hard magnetic materials are required to have a high coercivity, whereas soft magnetic materials are required to have a high maximum magnetization even if their coercivities are lower. The coercivity typical of hard magnetic materials is a characteristic relating to the stability of magnet, and as the coercivity is higher, the magnet can be used at a higher temperature and has a longer life.

NdFeB magnet is known as a magnet of a hard magnetic material. It is known that an NdFeB magnet can contain fine textures. It is also known that a quenched ribbon with a high coercivity that contains fine textures can be improved in temperature characteristics and in high-temperature coercivity. However, the coercivity of the NdFeB magnet decreases when it is sintered to form a bulk body. Various proposals have been therefore made to improve the characteristics, such as coercivity, of NdFeB magnets.

For example, Japanese Patent Application Publication No. 2000-252107 (JP-A-2000-252107) describes a semi-hard magnetic material which is represented by the composition formula Fe_{100-x-y}BₓR_{y}M_{z} (where Fe represents iron, B represents boron, R represents at least one rare-earth element selected from the group consisting of La, Ce, Pr, Nd and Sm, and M represents at least one element selected from the group consisting of Al, Si, Ti, V, Cr, Mn, Ni, Cu, Zn, Ga, Zr, Nb, Mo, Ag, Hf, Ta, W, Pt, Au and Pb), and x, y and z in the composition formula satisfy the relations 7 atomic %=x<15 atomic %, 0.5 atomic %=y=4 atomic %, and 0.1 atomic %=z=7 atomic %, respectively, and which contains a-Fe microcrystal that has an average crystal grain size of 100 nm or smaller as a constituent phase. As a specific example, a semi-hard material that has a coercivity which is lower than 10% of an NdFeB magnet as a hard magnetic material is disclosed.

In addition, Domestic Re-publication of PCT International Application 2002-030595 (JP-A1-2002-030595) describes a method for producing a nanocomposite permanent magnet that includes the steps of preparing an alloy melt that has a composition that is represented by the general formula Fe_{100-x-y-z}RₓQ_{y}M_{z} (where R represents at least one of Pr, Nd, Dy and Tb, Q represents at least one of B and C, and M represents at least one of Co, Al, Si, Ti, V, Cr, Mn, Ni, Cu, Ga, Zr, Nb, Mo, Ag, Pt, Au and Pb, and wherein x, y and z satisfy the relations 1 atomic %=x<6 atomic %, 15 atomic %=y=30 atomic %, and 0 atomic %=z=7 atomic %, respectively), forming a thin strip-shaped alloy by quenching the alloy melt by a strip casting process using a cooling roll, and heat treating the thin strip-shaped alloy.

However, the known techniques require the addition of a large amount of a rare metal such as Dy, Tb or Co or cannot produce an NdFeB magnet that has a high-temperature coercivity after being formed into a bulk body by sintering.

### SUMMARY OF THE INVENTION

The present invention provides a novel method for producing an NdFeB magnet that has a high-temperature coercivity even after being formed into a bulk body by sintering without the addition of a large amount of a rare metal such as Dy, Tb or Co.

A first aspect of the present invention relates to a method for producing an NdFeBGa magnet that includes forming a quenched ribbon composed of an Nd—Fe—B—Ga alloy; and subjecting the quenched ribbon to pressure sintering to obtain a sintered body.

In the method according to this aspect, the Nd—Fe—B—Ga alloy may have a composition that is represented by the general formula NdFeBGa_{A}, A may be a number that represent an atomic percent and may be between 1 and 3 inclusive.

In the method according to this aspect, the Nd—Fe—B—Ga alloy may have a composition that is represented by the general formula Nd_{y}Fe_{100-x-y}B_{z}Gaₓ, where x, y and z may be numbers that represent atomic percents, x may be between 1 and 3 inclusive, y may be a number that is larger than 12, and z is a number that may be larger than 6.

In the method according to this aspect, y may be 24 or smaller and z may be 12 or smaller, and y may be 14 or larger and z may be 7 or larger.

In the method according to this aspect, the Nd—Fe—B—Ga alloy may have a composition that is represented by the general formula Nd₁₅Fe₇₇B₇Ga₁.

In the method according to this aspect, subjecting the quenched ribbon to pressure sintering may be carried out by subjecting the quenched ribbon to electric current heating, and may include subjecting the quenched ribbon to electric current heating for 5 to 100 minutes under conditions of a contact pressure during sintering of 10 to 1000 MPa, a temperature that is 550° C. or higher and 600° C. or lower, and a vacuum of 10⁻² MPa or less.

In the method according to this aspect, forming the quenched ribbon may include supplying an alloy melt that has a composition that is represented by the general formula Nd_{y}Fe_{100-x-y-z}B_{z}Gaₓ onto a cooled roll.

The method according to this aspect may further include: removing columnar crystalline textures from the quenched ribbon; and pulverizing the quenched ribbon from which the columnar crystalline textures have been removed, and the quenched ribbon that is subjected to pressure sintering may be the quenched ribbon, which has been pulverized.

In the method according to this aspect, the quenched ribbon may be a ribbon-shaped magnet material,

A second aspect of the present invention relates to an NdFeBGa magnet material having a composition that is represented by the general formula Nd_{y}Fe_{100-x-y-z}B_{z}Gaₓ, where x is between 1 and 3 inclusive, y is between 14 and 24 inclusive, and z is between 7 and 12 inclusive.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a graph that shows the coercivity-temperature characteristics of a quenched ribbon and a sintered body according to one embodiment of the present invention and quenched ribbons according to comparative examples;

FIG. 2 is a graph that shows the magnetic characteristics of a quenched ribbon and a sintered body according to one embodiment of the present invention and a quenched ribbon and a sintered body according to a comparative examples; and

FIG. 3 is a schematic view of a single-roll furnace for use in the production of a quenched ribbon in examples of the present invention.

### DETAILED DESCRIPTION OF EMBODIMENTS

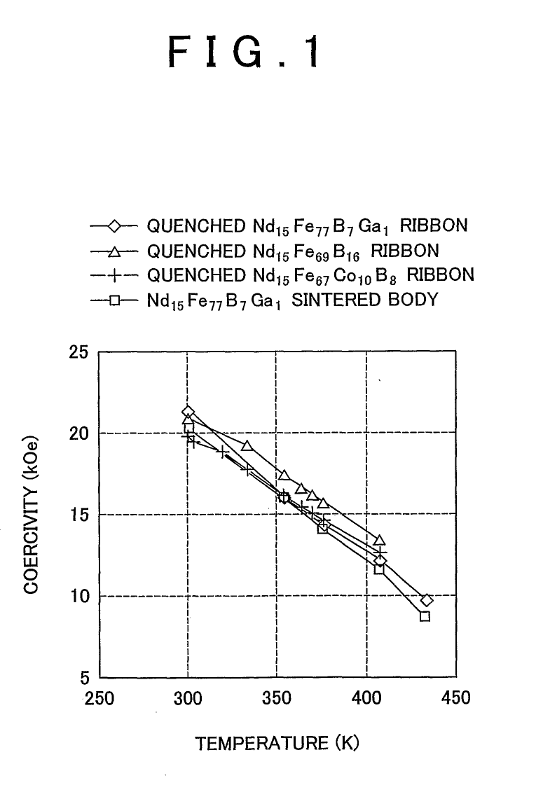

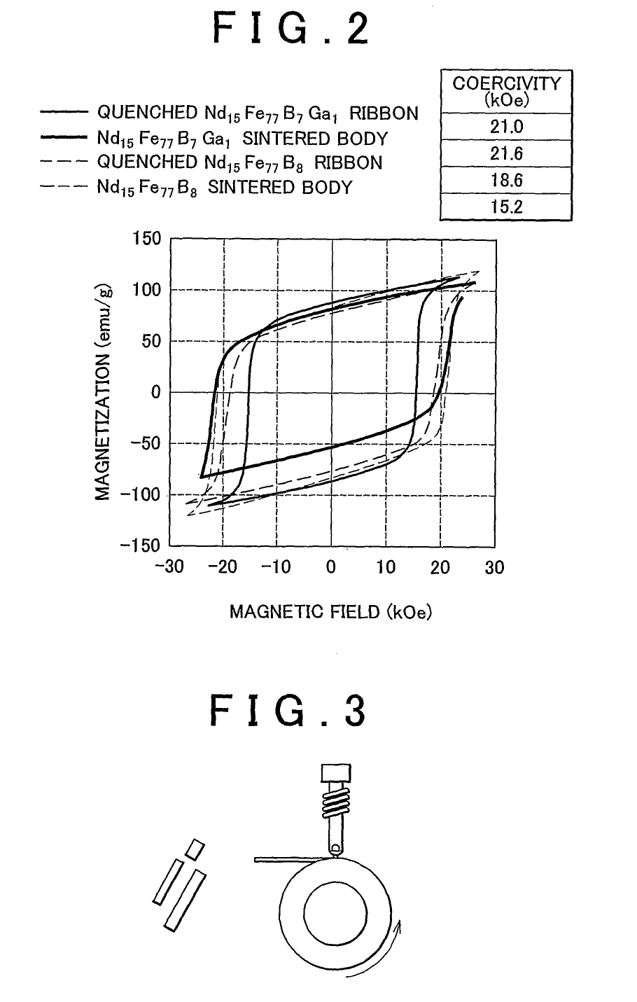

The present inventors conducted earnest studies to accomplish the above object and have reached the conclusion that an NdFeB magnet composed of multi-domain particles does not develop a coercivity without a magnetic field phase that prevents displacement and generation of domain walls and the coercivity-temperature characteristics thereof cannot be improved with the three elements alone and that this is because the degree of isolation of the main phase decreases (crystal grains grows or the grain boundary phase gets thinner) due to diffusion of elements between the main phase Nd₂Fe₁₄B and the grain boundary phase (Nd_{1.1}Fe₄B₄, NdO, etc.) or some other reasons during sintering. Then, as a result of additional studies, the present inventors have accomplished the present invention. Description is hereinafter made of an embodiment of the present invention with reference to the drawings. Referring now to FIG. 1 and FIG. 2, it can be understood that the NdFeB sintered body has coercivity-temperature characteristics and high-temperature coercivity that are much worse than those of the quenched NdFeB ribbon but the NdFeBGa sintered body that is obtained according to the embodiment of the present invention maintains the coercivity-temperature characteristics and high-temperature coercivity of the quenched NdFeBGa ribbon. FIG. 1 also indicates that the quenched NdFeBGa₁ ribbon according to the embodiment of the present invention is comparable or superior in coercivity-temperature characteristics to a quenched NdFeBCo₁₀ ribbon. It is believed that the maintenance of the high-temperature coercivity of the NdFeBGa sintered body is due to the fact that a sintered body which has excellent coercivity-temperature characteristics can be obtained by sintering a quenched ribbon that has isolated fine textures or fine textures into a bulk body.

In this embodiment, it is necessary to prepare a quenched ribbon (a ribbon-shaped magnet material) composed of an Nd—Fe—B—Ga alloy. In the production of the quenched ribbon, a high coercivity based on a coherent rotation model can be achieved by creating isolated fine textures that are smaller than the single-domain particle diameter or isotopic fine textures. Examples of the methods for accomplishing this include creation of microscopic textures by the formation of single-domain particles through a liquid quenching process such as a melt spinning process. One specific means for accomplishing this is to produce a quenched ribbon using a roll.

The Nd—Fe—B—Ga alloy in this embodiment is a quaternary alloy that is composed of Nd (Neodymium), Fe (Iron), B (Boron) and Ga (Gallium) and is obtained by substituting Ga for a part of one of the elements, such as B, of a ternary alloy which is composed of Nd, Fe and B. The Nd—Fe—B—Ga alloy in this embodiment may have a composition that is represented by the general formula NdFeBGa_{A}, A may be a number that represent an atomic percent and may be between 1 and 3 inclusive.

In this embodiment in particular, a quenched ribbon that has good coercivity-temperature characteristics can be obtained by creating a quenched Nd—Fe—B—Ga alloy ribbon that has a composition that is richer in Nd or B than that of the stoichiometric region (Nd₁₂Fe₈₂B₆). Thus, the Nd—Fe—B—Ga alloy preferably has a composition that is represented by the general formula Nd_{y}Fe_{100-x-y-z}B_{z}Gaₓ (where x, y and z are numbers that represent atomic percents and are in the ranges 1=x=3, 12<y and 6<z, respectively), more preferably Nd_{y}Fe_{100-x-y-z}B_{z}Gaₓ (1=x=3, 12 <y=24 and 6<z=12), and most preferably Nd₁₅Fe₇₇B₇Ga₁.

The quenched Nd—Fe—B—Ga alloy ribbon of this embodiment can be obtained by preparing an alloy ingot from specified amounts of Nd, Fe, FeB and Ga that give the above atomic percents in a melting furnace, such as an arc melting furnace, and casting the resulting alloy ingot with a casting device, such as a roll furnace that includes, for example, a melt reservoir that reserves alloy melt, a nozzle that supplies the melt, a cooling roll, a winder, a motor for the cooling roll, a winder motor, and a cooler for the cooling roll.

In this embodiment, it is necessary to subject the quenched Nd—Fe—B—Ga alloy ribbon to pressure sintering. The pressure sintering of the quenched ribbon can be carried out by, for example, a method that includes pulverizing the residual that remains after the removal of columnar crystalline textures from the quenched ribbon, and subjecting the pulverized material to electric current sintering with an electric current sintering apparatus including dies, a temperature sensor, a control unit, a power supply unit, a heating element, electrodes, a heat insulating material, a metal support, and a vacuum chamber.

The pressure sintering can be carried out by means of electric current sintering for 5 to 100 minutes under conditions of, for example, a contact pressure during sintering of 10 to 1000 MPa, a temperature between 550° C. and 600° C. inclusive, and a vacuum of 10⁻² MPa or less. A bulk body that maintains the coercivity-temperature characteristics and high-temperature coercivity of the quenched NdFeBGaₓ ribbon can be obtained by the above pressure sintering process.

Examples of the present invention are described below. In each of the following examples, the magnetic characteristics of the sintered body were measured with a VSM measurement system (vibrating sample magnetometer system) manufactured by Lake Shore Cryotronics, Inc. In each of the following examples, the quenched ribbon was prepared using a single-roll furnace that is schematically shown in FIG. 3.

Example 1 is described below. Preparation of quenched ribbon: Specified amounts of Nd, Fe, FeB and Ga that gave an atomic ratio of Nd, Fe, B and Ga of 15:77:7:1 were weighed and an alloy ingot was prepared in an arc melting furnace. Then, the alloy ingot was melted by applying high-frequency waves in the single-roll furnace. The alloy melt was then sprayed onto a copper roll under the following single-roll furnace use conditions, thereby obtaining a quenched ribbon. Single-roll furnace use conditions were nozzle diameter: 0.6 mm, clearance: 0.7 mm or 1.0 mm, spray pressure: 0.4 kg/cm³, roll speed: 2000 rpm or 2350 rpm, and melt temperature: 1450° C. The magnetic characteristics of the resulting quenched Nd₁₅Fe₇₇B₇Ga₁ ribbon were evaluated using the high-temperature VSM. The result is summarized in FIG. 1.

Preparation of sintered body: The parts of the resulting quenched ribbon that had turned into columnar crystalline textures were removed from by visual inspection and magnetic separation. The remnant was manually pulverized in a plastic bag, and the pulverized sample was charged in a carbon die of an electric current sintering apparatus. Then, a sintered body was prepared under the following conditions; sintering condition atmosphere: vacuum (10 MPa), heat treatment temperature: 570° C., temperature increase rate: 20° C./min, retention time: 15 minutes, molding contact pressure: 40 MPa, contact pressure during sintering: 100 MPa. The resulting Nd₁₅Fe₇₇B₇Ga₁ sintered body was cut into a specified size (approximately 2×2×2 mm), and the magnetic characteristics were evaluated using the VSM. The result is summarized in FIG. 2.

Comparative Example 1 is described below. Preparation of quenched ribbon: Specified amounts of Nd, Fe and FeB that gave an atomic ratio of Nd, Fe and B of 15:69:16 were weighed and an alloy ingot was prepared in an arc melting furnace. Then, the alloy ingot was melted by applying high-frequency waves in the single-roll furnace. The alloy melt was then sprayed onto a copper roll, to prepare a quenched ribbon under the same conditions as described before. The magnetic characteristics of the resulting quenched Nd₁₅Fe₆₉B₁₆ ribbon were evaluated using the high-temperature VSM. The result is summarized in FIG. 1.

Preparation of sintered body: A sintered body was prepared from the resulting quenched ribbon in the same manner as in Example 1. except that the heat treatment temperature was changed to 600° C. The resulting Nd₁₅Fe₆₉B₁₆ sintered body was cut into a specified size (approximately 2×2×2 mm), and the magnetic characteristics were evaluated using the VSM. The result is summarized in FIG. 2.

Comparative Example 2 is described below. Preparation of quenched ribbon: Specified amounts of Nd, Fe, FeB and Co that gave an atomic ratio of Nd, Fe, Co and B of 15:67:10:8 were weighed and an alloy ingot was prepared in an arc melting furnace. Then, a quenched ribbon was prepared in the same manner as in Example 1. The magnetic characteristics of the resulting quenched Nd₁₅Fe₆₇Co₁₀B₇ ribbon were evaluated using the high-temperature VSM. The result is summarized in FIG. 1.

Preparation of sintered body: The parts of the resulting quenched ribbon that had turned into columnar crystalline textures were removed from by visual inspection and magnetic separation. The remnant was manually pulverized in a plastic bag, and the pulverized sample was charged in a carbon die of an electric current sintering apparatus. Then, a sintered body was prepared in the same manner as in Example 1. The resulting Nd₁₅Fe₆₇Co₁₀B₇ sintered body was cut into a specified size (approximately 2×2×2 mm), and the magnetic characteristics were evaluated using the VSM.

Comparative Example 3 is described below. Preparation of quenched ribbon: Specified amounts of Nd, Fe and FeB that gave an atomic ratio of Nd, Fe and B of 15:77:8 were weighed and an alloy ingot was prepared in an arc melting furnace. Then, a quenched ribbon was prepared in the same manner as in Example 1. The magnetic characteristics of the resulting quenched Nd₁₅Fe₇₇B₈ ribbon were evaluated using the high-temperature VSM. The result is summarized in FIG. 1.

Preparation of sintered body: A sintered body was prepared from the resulting quenched ribbon in the same manner as in Example 1 except that the heat treatment temperature was changed to 600° C. The resulting Nd₁₅Fe₇₇B₈ sintered body was cut into a specified size (approximately 2×2×2 mm), and the magnetic characteristics were evaluated using the VSM. The result is summarized in FIG. 2.

For comparison between Example and Comparative Examples, the coercivities of the quenched ribbons and the sintered bodies obtained as results of the evaluation using the VSM are summarized below: quenched Nd₁₅Fe₇₇B₇Ga₁ ribbon coercivity (kOe)=21.0; Nd₁₅Fe₇₇B₇Ga₁ sintered body coercivity (kOe)=21.6; quenched Nd₁₅Fe₇₇B₈ ribbon coercivity (kOe)=18.6; Nd₁₅Fe₇₇B₈sintered body coercivity (kOe)=15.2; quenched Nd₁₅Fe₆₇Co₁₀B₇ ribbon coercivity (kOe)=18.5; and Nd₁₅Fe₆₇Co₁₀B₇ sintered body coercivity (kOe)=17.6.

The above results also indicate that the room-temperature coercivity decreases when a ternary-system Nd₁₅Fe₇₇B₈ is turned from a quenched ribbon into a sintered body but a sintered body that has a room-temperature coercivity that is comparable or superior to that of the quenched ribbon can be obtained when a part of B is substituted by Ga to form a quaternary-system Nd₁₅Fe₇₇B₇Ga₁. In addition, when a part of B is substituted by Ga to form a quaternary-system Nd₁₅Fe₇₇B₇Ga₁, a sintered body that has coercivity-temperature characteristics that are comparable to those of the quenched ribbon can be obtained. This means that a sintered body that has excellent coercivity-temperature characteristics can be produced without adding a large amount of a rare metal such as Dy, Tb or Co.

According to this embodiment, a sintered body that has excellent coercivity-temperature characteristics can be produced and an NdFeBGa magnet that has a high coercivity can be provided.

While some embodiments of the invention have been illustrated above, it is to be understood that the invention is not limited to details of the illustrated embodiments, but may be embodied with various changes, modifications or improvements, which may occur to those skilled in the art, without departing from the scope of the invention.

1. A method for producing an NdFeBGa magnet, comprising:
forming a quenched ribbon composed of an Nd—Fe—B—Ga alloy; and
subjecting the quenched ribbon to pressure sintering to obtain a sintered body,
wherein subjecting the quenched ribbon to pressure sintering is carried out by subjecting the quenched ribbon to electric current heating.

2. The method according to claim 1,
wherein the Nd—Fe—B—Ga alloy has a composition that is represented by the general formula NdFeBGa_{A}, and
A is a number that represent an atomic percent and is between 1 and 3 inclusive.

3. The method according to claim 1,
wherein the Nd—Fe—B—Ga alloy has a composition that is represented by the general formula Nd_{y}Fe_{100-x-y-z}B_{z}Gaₓ,
x, y, and z are numbers that represent atomic percents,
x is between 1 and 3 inclusive,
y is a number that is larger than 12, and
z is a number that is larger than 6.

4. The method according to claim 3,
wherein y is 24 or smaller, and
z is 12 or smaller.

5. The method according to claim 3,
wherein y is 14 or larger, and
z is 7 or larger.

6. The method according to claim 1,
wherein the Nd—Fe—B—Ga alloy has a composition that is represented by the general formula Nd₁₅Fe₇₇B₇Ga₁.

7. (canceled)

8. The method according to claim 1,
wherein subjecting the quenched ribbon to pressure sintering includes subjecting the quenched ribbon to electric current heating for 5 to 100 minutes under conditions of a contact pressure during sintering of 10 to 1000 MPa, a temperature that is 550° C. or higher and 600° C. or lower, and a vacuum of 10⁻² MPa or less.

9. The method according to claim 1,
wherein forming the quenched ribbon includes supplying an alloy melt that has a composition that is represented by the general formula Nd_{y}Fe_{100-x-y-z}B_{z}Gaₓ onto a cooled roll.

10. The method according to claim 1, further comprising:
removing columnar crystalline textures from the quenched ribbon; and
pulverizing the quenched ribbon from which the columnar crystalline textures have been removed,
wherein the quenched ribbon that is subjected to pressure sintering is the quenched ribbon, which has been pulverized.

11. The method according to claim 1,
wherein the quenched ribbon is a ribbon-shaped magnet material.

12. (canceled)

13. A method for producing an NdFeBGa magnet, comprising:
forming a quenched ribbon composed of an Nd—Fe—B—Ga alloy; and
subjecting the quenched ribbon to pressure sintering to obtain a sintered body,
removing columnar crystalline textures from the quenched ribbon; and
pulverizing the quenched ribbon from which the columnar crystalline textures have been removed,
wherein the quenched ribbon that is subjected to pressure sintering is the quenched ribbon, which has been pulverized.

14. The method according to claim 13,
wherein the Nd—Fe—B—Ga alloy has a composition that is represented by the general formula NdFeBGa_{A}, and
A is a number that represents an atomic percent and is between 1 and 3 inclusive.

15. The method according claim 13,
wherein the Nd—Fe—B—Ga alloy has a composition that is represented by the general formula Nd_{y}Fe_{100-x-y-z}B_{z}Gaₓ,
x, y, and z are numbers that represent atomic percents,
x is between 1 and 3 inclusive,
y is a number that is larger than 12, and
z is a number that is larger than 6.

16. The method according to claim 15,
wherein y is 24 or smaller, and
z is 12 or smaller.

17. The method according to claim 15,
wherein y is 14 or larger, and
z is 7 or larger.

18. The method according to claim 13,
wherein the Nd—Fe—B—Ga alloy has a composition that is represented by the general formula Nd₁₅Fe₇₇B₇Ga₁.

19. The method according to claim 13,
wherein forming the quenched ribbon includes supplying an alloy melt that has a composition that is represented by the general formula Nd_{y}Fe_{100-x-y-z}B_{z}Gaₓ onto a cooled roll.

20. The method according to claim 13,
wherein the quenched ribbon is a ribbon-shaped magnet material.
